(19) United States
(12) Patent Application Publication
(10) Pub. No.: US 2016/0081300 A1
(43) Pub. Date: Mar. 24, 2016

(54) TREATMENT APPLICATOR FOR RODENTS

(71) Applicant: Denny Harroff, Garland, TX (US)

(72) Inventor: Denny Harroff, Garland, TX (US)

(21) Appl. No.: 14/698,134

(22) Filed: Apr. 28, 2015

Related U.S. Application Data
(60) Provisional application No. 62/053,578, filed on Sep. 22, 2014.

(51) Int. Cl. A01K 13/00

(52) U.S. Cl. CPC A01K 13/003

(57) ABSTRACT

The invention disclosed provides devices that passively apply a substance, such as a liquid or powder parasite repellant, insecticide or the like to a small animal. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This application is related to and claims priority from U.S. Provisional Patent Application No. 62/053,578 to Harroff, filed Sep. 9, 2014 and entitled PARASITE TREATMENT APPLICATOR.

### TECHNICAL FIELD OF THE INVENTION

The present invention relates to systems and methods of reducing the population of parasites.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Owners of outdoor pets are familiar with the issue of parasite infestations. Fleas, ticks, lice, mosquitoes, worms and the like can harm or even kill a pet, and can pose a health threat to people. While some parasites live in the wild in-situ, infestations are typically promulgated by rodents, such as mice, rats, squirrels, or rabbits, for example.

For example, ticks are capable of causing anemia. And, certain female ticks can also cause a paralysis as a result of a toxin they produce while feeding. Further, ticks are capable of causing many other diseases such as Lyme disease or Rocky Mountain spotted fever. Lyme disease can cause arthritis and swelling of joints, which is painful and debilitating. Similarly, Rocky Mountain spotted fever symptoms include fever and lameness. These and many other diseases can be transmitted to the human population. Accordingly, there is a need for systems, methods and devices that retard the transmission of diseases by parasites. The present invention provides a system and apparatus that applies treatments to wild animals to prevent parasites and other maladies.

### BRIEF DESCRIPTION OF THE DRAWINGS AND TABLE

Various aspects of the invention, as well as an embodiment, are better understood by reference to the following detailed description. To better understand the invention, the detailed description should be read in conjunction with the drawings.

FIG. 1 illustrates an inventive treatment applicator.

FIG. 2 illustrates the inventive treatment applicator having a securing system.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “attaching” may be done by hook-and-loop attachment (such as Velcro®), snaps, hooks, belts, etc., and so a use of the word attaching invokes all methods of attachment known in and anticipated by the art, and all other modes of that word and similar words).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

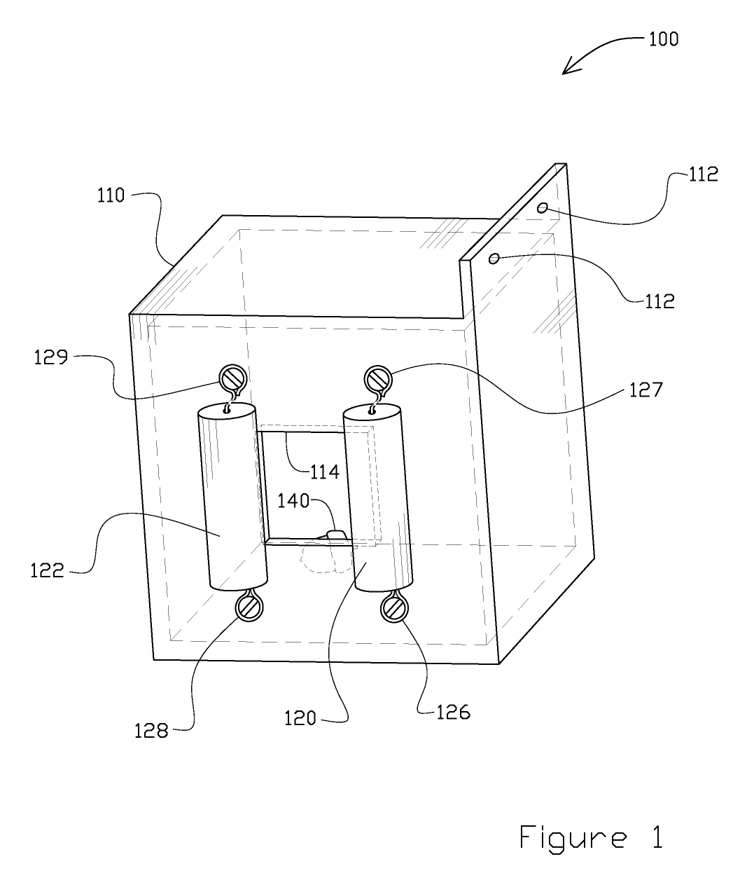

FIG. 1 illustrates an inventive treatment applicator 100. The applicator 100 comprises a container 110 illustrated here as a box; however, it is appreciated that any shaped container could be used and various alternative shapes have alternative advantages. For example, the container 110 could be cylindrical or partially cylindrical (similar in shape to a mailbox), or even rounded or ornamental. The container 110 has an opening 114 that is sufficiently large to allow an animal to have limited access to food 140 maintained therein. Ideally, the applicator 100 treats rodent sized animals such as squirrls, mice/rats, rabbits, skunks, foxes, and the like. For example, the opening 114 could be large enough to allow a racoon arm to insert therethrough, while being small enough to prevent its head to extend therethrough, and this is achievable with an opening of approximately one-half inch to three inches in radius, such as two inches in radius and preferably one inch in radius. The food 140 is preferably a weather-resilliant food source selected for an animal targeted for treatment (“the targeted animal”), such as grains including wheat grain, fruit, food pellets, seed, bread, “rodent blocks” or other foods that attract rodents.

Coupled to the container 110 are a first treatment applicator 120 and a second treatment applicator 122, which are preferably made of a porous material that accepts a liquid or powder treatment, such as pyrethrins, pyrethroids, fipronil, insect growth regulators (IGRs), carbamate, imidacloprid, amitraz, selamectin, nitenpyram, spinosad, or citrus extract, for example. The first and second treatment applicators 120, 122 are coupled to the container 110, and preferably maintained between top hooks 127, 129 and bottom hooks 126, 128 that are attached to the container 110 proximate to the opening 114—as illustrated one on either side of the opening 114—and separated from each other sufficiently to not obstruct an animal's access to the food 140, yet close enough to the opening 114 and/or each other to insure that the animal brushes against either or both of the treatment applicator(s) 120, 122. In one embodiment, the treatment applicators 120, 122 are in part made from a treatment chemical (that is to say that they are replacable with additional treatment applicators that are pre-treated).

The container preferably comprises a means to mount, attach, or otherwise secure the container 110 to another surface one or more mounting hole(s) 112 which may couple to a nail, rivit, nut/bolt, or other securing means that allow the container to be hung and/or chained to a surface. Additionally, a container 110 may comprise a bottom portion 130 that is weather resiliant and attachable to a grouind surface such that the device 100 may be secured to or otherwise set on a floor or ground surface.

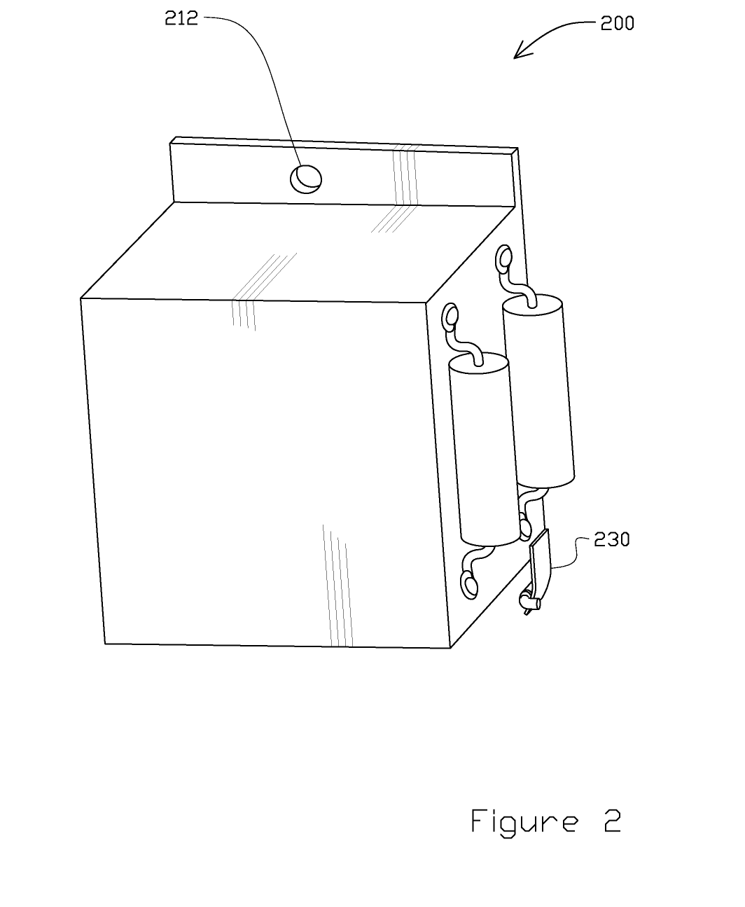

FIG. 2 illustrates the inventive treatment applicator having a securing system. An inventive securing system generally includes at least one hole 212 for receiving a hook, screw or other securing means, and an appendage for preventing the torquing or other articulation of a container according to the invention, such as a hook 230. The hole 212 is preferably located above a center of gravity of the container 110. Accordingly, in one embodiment the container 110 also has a torquing hook 230 coupled to the container 110 that allows the container 110 to pivot about the mounting hole 112. Other rodent treatments, such as D-mannose for population control, may be administered via an inventive device.

Though the invention has been described with respect to specific preferred embodiments, many variations and modifications will become apparent to those skilled in the art upon reading the present application. Specifically, the invention may be altered in ways readily apparent to those of ordinary skill in the art upon reading the present disclosure. It is therefore the intention that the appended claims and their equivalents be interpreted as broadly as possible in view of the prior art to include all such variations and modifications.

I claim:

1. An apparatus for administering a treatment chemical to a rodent, comprising:
a generally cuboid container having a top, a bottom, a front, a back, a left side and a right side;
the container front having an opening therein, the opening large enough for a rodent located outside of the container to gain access through the opening to the interior of the container;
the front of the container having first treatment applicator attached thereto via a first coupling means, the treatment applicator comprising a porous material maintaining a treatment chemical.

2. The apparatus of claim 1 wherein the treatment chemical is an insecticide.

3. The apparatus of claim 1 wherein the treatment chemical is an anti-fertility compound including D-Mannose.

4. The apparatus of claim 1 wherein the container has a food in its interior.

5. The apparatus of claim 1 wherein the first coupling means comprises a first hook coupled to the front proximate to the opening.

6. The apparatus of claim 1 wherein the food is a weather resilient food comprising a chemical treatment.

7. The apparatus of claim 1 wherein the porous material is a foam.

8. The apparatus of claim 1 wherein the porous material is a synthetic sponge.

9. The apparatus of claim 1 wherein the porous material is a natural sponge.

10. The apparatus of claim 1 wherein the first treatment applicator is irremovably coupled to the coupling means.

11. The apparatus of claim 1 wherein the treatment chemical is an insecticide.

12. The apparatus of claim 1 wherein the treatment chemical is an insect growth regulator.

13. The apparatus of claim 1 wherein the treatment chemical is a pyrethrin.

14. The apparatus of claim 1 wherein the container comprises a first mounting hole for receiving a mounting means.

15. The apparatus of claim 1 further comprising a torque hook selectively located to offset any torque forces of the container relative to the mounting hole.

16. An apparatus for treating a rodent with a chemical, comprising:
a container means having a mounting means located thereon, and a means for accessing an interior of the container;
the container means comprising a food means in an interior portion; and
a treatment means coupled to the container means proximate to the means for accessing an interior, such that when an animal attempts to access the food means the animal is exposed to a treatment chemical maintained in the treatment means.
